(19) United States
(12) Patent Application Publication
(10) Pub. No.: US 2013/0037154 A1
(43) Pub. Date: Feb. 14, 2013

(54) MULTILAYER TUBE FOR TRANSMISSION OIL COOLER

(71) Applicants: Jee Young YOUN, Incheon (KR); Seung Don ZU, Incheon (KR)

(72) Inventors: Jee Young YOUN, Incheon (KR); Seung Don ZU, Incheon (KR)

(73) Assignee: HYUNDAI MOTOR COMPANY, Seoul (KR)

(21) Appl. No.: 13/253,347

(22) Filed: Oct. 5, 2011

(30) Foreign Application Priority Data
Aug. 9, 2011 (KR) 10-2011-0079287

(51) Int. Cl. F16L 55/00; B32B 1/08

(52) U.S. Cl. 138/103; 428/36.91

(57) ABSTRACT

The present invention provides a multilayer tube for a transmission oil cooler. The multilayer tube for the transmission oil cooler includes a hose part having a multilayer structure. The multilayer structure includes a hollow inner-layer hose and an outer-layer hose. The hollow inner-layer hose is formed of a polyphthalamide or polyamide material. The outer-layer hose is formed of a polyamide612 or polyamide610 and is stacked on the outer surface of the inner-layer hose.

### CROSS-REFERENCE TO RELATED APPLICATION

This application claims under 35 U.S.C. §119(a) the benefit of Korean Patent Application No. 10-2011-0079287 filed Aug. 9, 2011, the entire contents of which are incorporated herein by reference.

### BACKGROUND

(a) Technical Field

The present invention relates to a multilayer tube for a transmission oil cooler. More particularly, it relates to a multilayer tube for a transmission oil cooler that can meet heat resistance and chemical resistance requirements for parts in which transmission oil flows and can improve fabrication efficiency and productivity.

(b) Background Art

Generally, a Transmission Oil Cooler (TOC) is a device that cools oil of an automatic transmission to an optimal temperature. The TOC includes an inlet tube for guiding transmission oil discharged from a transmission with a high temperature to a radiator system and an outlet tube for guiding the transmission oil after heat-exchange in the radiator system for recirculation into the transmission.

Referring to FIG. 1, transmission oil discharged from a transmission with a high temperature flows into a radiator system through an inlet tube 1 of a transmission oil cooler, and is heat-exchanged in the radiator system. Thereafter, the cooled transmission oil flows again into the transmission through an outlet tube 2 of the transmission oil cooler.

On the other hand, a typical tube for a transmission oil cooler has a structure in which a pipe 4 formed of a metal material and a hose 5 formed of a rubber material are connected to each other by a clamp 6. However, the manufacturing and assembling processes of the typical tube having such a structure are complex, and the clamp 6 separated from the hose 5 for repair has to be reassembled after the repair work. Also, transmission oil may leak during the above process.

Also, a typical tube for a transmission oil cooler has a limitation in that a gasket and a metal nut has to be installed in a radiator end tank to connect the pipe 4 formed of a metal material for connection with a counterpart, i.e., the radiator end tank. Thus, the number of components of the counterpart may be excessively increased, and the assembling process of parts and counterparts may become complex. Furthermore, airtightness may be reduced at a high internal pressure.

In addition, an anti-corrosive coating must be applied on the surface of the pipe 4 formed of a metal material and the clamp 6 to prevent corrosion.

The above information disclosed in this Background section is only for enhancement of understanding of the background of the invention and therefore it may contain information that does not form the prior art that is already known in this country to a person of ordinary skill in the art.

### SUMMARY OF THE DISCLOSURE

The present invention provides a multilayer tube for a transmission oil cooler having a multilayer structure formed by performing double extrusion of an inner-layer hose formed of polyphthalamide or polyamide with high heat resistance and an outer-layer hose formed of polyamide612 or polyamide610 with high chemical resistance.

In one aspect, the present invention provides a multilayer tube for a transmission oil cooler, including a hose part having a multilayer structure including: a hollow inner-layer hose formed of a polyphthalamide or polyamide material; and an outer-layer hose formed of a polyamide612 or polyamide610 and stacked on the outer surface of the inner-layer hose.

In a exemplary embodiment, the multilayer tube for the transmission oil cooler may further include a quick connector part integrally disposed at both ends of the hose part.

In another exemplary embodiment, the multilayer tube for the transmission oil cooler may further include a thermal fusion-type adhesive disposed between the inner-layer hose and the outer-layer hose that are doubly extruded, for strong joining of the inner-layer hose and the outer-layer hose.

Other aspects and exemplary embodiments of the invention are discussed infra.

### BRIEF DESCRIPTION OF THE DRAWINGS

The above and other features of the present invention will now be described in detail with reference to certain exemplary embodiments thereof illustrated the accompanying drawings which are given hereinbelow by way of illustration only, and thus are not limitative of the present invention, and wherein:

FIG. 1 is a view illustrating an oil cooling system of a transmission for a vehicle;

FIG. 2 is a perspective view illustrating a typical tube for a transmission oil cooler;

FIG. 3 is a perspective view illustrating a multilayer tube for a transmission oil cooler according to an embodiment of the present invention;

FIG. 4 is a view illustrating a structure of a hose part of a multilayer tube for a transmission oil cooler according to an embodiment of the present invention; and

FIG. 5 is a schematic view illustrating a nipple structure for a quick connector of a radiator end tank to which a quick connector of a multilayer tube of a transmission oil cooler is coupled according to an embodiment of the present invention.

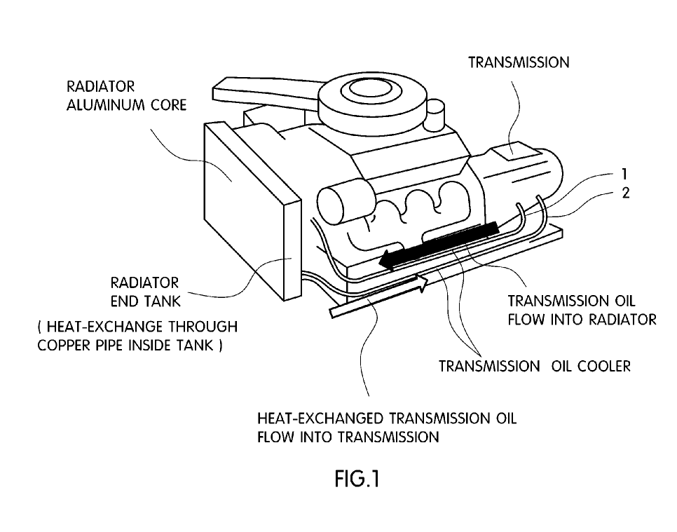

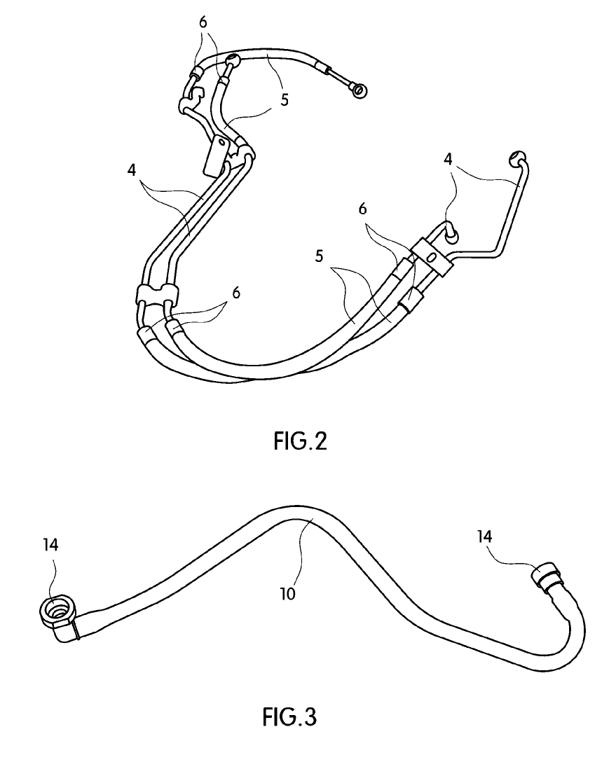

Reference numerals set forth in the Drawings includes reference to the following elements as further discussed below:
10: hose part
11: inner-layer hose
12: outer-layer hose
13: adhesive layer
14: quick connector part

It should be understood that the appended drawings are not necessarily to scale, presenting a somewhat simplified representation of various preferred features illustrative of the basic principles of the invention. The specific design features of the present invention as disclosed herein, including, for example, specific dimensions, orientations, locations, and shapes will be determined in part by the particular intended application and use environment.

In the figures, reference numbers refer to the same or equivalent parts of the present invention throughout the several figures of the drawing.

### DETAILED DESCRIPTION

Hereinafter reference will now be made in detail to various embodiments of the present invention, examples of which are illustrated in the accompanying drawings and described below. While the invention will be described in conjunction with exemplary embodiments, it will be understood that present description is not intended to limit the invention to those exemplary embodiments. On the contrary, the invention is intended to cover not only the exemplary embodiments, but also various alternatives, modifications, equivalents and other embodiments, which may be included within the spirit and scope of the invention as defined by the appended claims.

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g., fuels derived from resources other than petroleum). As referred to herein, a hybrid vehicle is a vehicle that has two or more sources of power, for example both gasoline-powered and electric-powered vehicles.

The above and other features of the invention are discussed infra.

Generally, a typical tube for a transmission oil cooler, in which transmission oil of high temperature and pressure flows, is formed of a material having high heat resistance and high strength to endure such high temperature and pressure.

In order to improve a limitation of a typical tube for a transmission oil cooler, the present invention provides a multilayer tube for a transmission oil that can meet heat resistance and chemical resistance required for parts in which transmission oil flows, using a polyamide (PA) or polyphthalamide (PPA) material.

However, since PA and PPA materials have high heat resistance but do not have high chemical resistance, cracks may occur in parts manufactured using PA and PPA materials due to chemical invasion of materials such as calcium chloride and zinc chloride.

Particularly, when chemical invasion is applied to a tube part for a transmission oil cooler in which high temperature and pressure transmission oil flows and thus a high internal temperature of about 170° C. and an internal pressure of about 30 bar are applied, durability may be significantly reduced at a part that is formed of PPA material with a relatively low chemical resistance.

A multilayer tube for a transmission oil cooler according to an embodiment of the present invention may be formed to have an integral multilayer hose structure, by doubly extruding a polyphthalamide or polyamide material with high heat resistance and a polyamide612 or polyamide610 material with high chemical resistance.

Hereinafter, exemplary embodiments will be described in detail with reference to the accompanying drawings.

As shown in FIG. 3, a multilayer tube for a transmission oil cooler may include a hollow hose part 10 having a flow passage allowing transmission oil to move between a transmission and a radiator end tank, and a quick connector part 14 integrally formed at both ends of the hollow hose part 10.

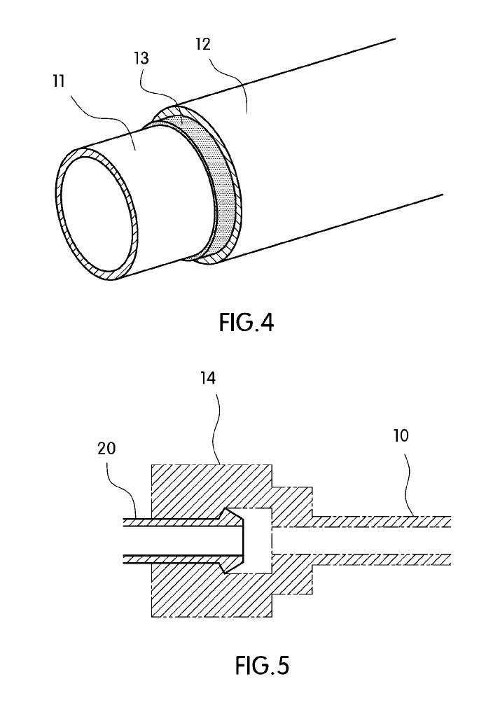

As shown in FIG. 4, the hose part 10 may include an inner-layer hose 11 having a hollow pipe structure in which transmission oil substantially flows, and an outer-layer hose 12 stacked on the outer surface of the inner-layer hose 11.

The inner-layer hose 11 may be formed of a polyphthalamide or polyamide with high heat resistance and flexibility, and the outer-layer hose 12 may be formed polyamide612 or polyamide610 having excellent chemical resistance and having a melting point of about 250° C. or more and an elastic modulus of about 500 MPa to about 1,200 MPa.

In other words, the hose part 10 may have a multilayer hose structure in which the outer-layer hose 12 formed of a polyamide612 or polyamide610 material is stacked on the inner-layer hose 11 formed of a polyphthalamide or polyamide material. For this, the hose part 10 may be formed by doubly extruding the inner-layer hose 11 and the outer-layer hose 12.

Also, for strong joining between the inner-layer hose 11 and the outer-layer hose 12, a thermal fusion-type adhesive (e.g., hot melt) may be interposed between the inner-layer hose 11 and the outer-layer hose 12 that are doubly extruded to improve the adhesive performance between interfaces.

The thermal fusion-type adhesive may be used between materials that are doubly extruded for formation of the hose part 10, and may be melted by the heat of the materials to increase the adhesive performance between the inner-layer hose 11 and the outer-layer hose 12. Accordingly, as shown in FIG. 4, a thin adhesive layer 13 may be disposed between the inner-layer hose 11 and the outer-layer hose 12.

The quick connector part 14, which is a part for quick and convenient coupling with a counterpart (i.e., radiator end tank), may be integrally formed at both ends of the hose part 10 during the extrusion of the hose part 10. As shown in FIG. 5, a quick connector nipple 20 may be provided on the radiator end tank to couple the quick connector part 14 of the multilayer tube for the transmission oil cooler to the radiator end tank.

The quick connector nipple 20 of the radiator end tank may be formed on a portion which transmission oil flow in and out.

The quick connector part 14 may be formed to have a shape that can engage with the outside of the quick connector nipple 20 of the radiator end tank, and the quick connector nipple 20 may be formed to have a shape that can be inserted into the quick connector part 14.

Since the quick connector part 14 is provided on the both ends of the hose part 10 and the quick connector nipple structure is applied to the radiator end tank, a gasket and a metal nut that are parts for coupling a metal pipe of a related-art tube for a transmission oil cooler can be omitted.

Since the multilayer tube for the transmission oil cooler according to the embodiment of the present invention has an integral structure, the number of parts can be minimized, allowing easy assembling of a part and a counterpart and simplification of the fabrication process. Thus, airtightness can be improved at a high internal pressure.

Also, since the multilayer tube for the transmission oil cooler is manufactured using plastic materials such as polyphthalamide or polyamide to satisfy heat resistance and chemical resistance required for parts, it can have durability that can endure high internal temperature and pressure caused by transmission oil.

Furthermore, since the multilayer tube for the transmission oil cooler is manufactured by double extrusion of two materials, the productivity and the in-line fabrication can be improved, and the cost-saving can be achieved. Also, since plastic materials are used, reduction of weight can be achieved, and the anti-corrosive coating can be omitted.

A multilayer tube for an oil cooler according to an embodiment of the present invention has an integral multilayer hose structure that satisfies both heat resistance and chemical resistance that are required for parts. The multilayer tube can be manufactured by double-extruding a material having excellent heat resistance and chemical resistance by a continuous process. Thus, the improvement of productivity can be achieved, and reduction of weight and cost-saving can be achieved. Also, fabrication with counterparts and performance upon component repair can be improved using a quick connector part at both ends.

The invention has been described in detail with reference to exemplary embodiments thereof. However, it will be appreciated by those skilled in the art that changes may be made in these embodiments without departing from the principles and spirit of the invention, the scope of which is defined in the appended claims and their equivalents.

What is claimed is:

1. A multilayer tube for a transmission oil cooler, comprising a hose part having a multilayer structure comprising:
a hollow inner-layer hose formed of a polyphthalamide or polyamide material; and
an outer-layer hose formed of a polyamide612 or polyamide610 and stacked on the outer surface of the inner-layer hose.

2. The multilayer tube of claim 1, further comprising a quick connector part integrally disposed at both ends of the hose part.

3. The multilayer tube of claim 1, further comprising a thermal fusion-type adhesive disposed between the inner-layer hose and the outer-layer hose that are doubly extruded, for strong joining of the inner-layer hose and the outer-layer hose.
